(19) United States
(12) Patent Application Publication
(10) Pub. No.: US 2008/0163065 A1
(43) Pub. Date: Jul. 3, 2008

(54) USING A LIGHT SOURCE TO INDICATE NAVIGATION SPOTS ON A WEB PAGE

(75) Inventors: Elina Vartiainen, Helsinki (FI); Jarmo Kauko, Tampere (FI); Janne P. Kaasalainen, Helsinki (FI); Andrei Popescu, London (GB)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,043

(22) Filed: Dec. 29, 2006

(51) Int. Cl. G06F 3/00

(52) U.S. Cl. 715/738

(57) ABSTRACT

A method and system for identifying navigation points on a web page using light sources. A user browses to a web page and at least one area on the web page is selected. The selected area is defined as a navigation point, and the navigation point is highlighted by being illuminated with a light source.

### BACKGROUND

1. Field

The disclosed embodiments generally relate to user interfaces and in particular to improving navigation of content in a web document.

2. Brief Description of Related Developments

Current web browsers on mobile devices generally offer a “keyhole” view to large web documents that have been designed for browsing on machines equipped with high-resolution displays (e.g. PCs, etc). This situation can make it cumbersome or difficult for users to locate and navigate to the interesting information in a large web document, particularly since mobile devices generally do not have the screen capacity to display large web documents. Moreover, once a user succeeds in finding desired information on such a web document, the user will have to repeat the entire process of locating and navigating to the same information next time document is accessed and visited.

For example, one version of the Opera™ browser would provide a mechanism that allowed a user to set bookmarks (or tags) inside a web document. However, in this system the tags are temporary and are lost when the user refreshes the document. If the tags are temporary, every time the user goes to the general news web page to check the latest news, the user has to manually locate and navigate to the sections that are of most interest to the user. It would be advantageous for a user to be able to set tags inside a news portal that would allow the user to quickly navigate to, for example, a news category on a news web page that is of most interest to the user.

Another version of the Opera™ browser provides a mechanism called “Jump to Text” that lets the user “jump” to the first portion of text in a web page, skipping the content in between. This navigation point is visualized as a line in the vertical scroll bar when using the “Fit to screen” mode (the layout of a web page is changed to fit into one column). When viewing the web page in the normal mode, Opera™ does not provide this function at all. Furthermore, the user cannot decide where the first portion of text, that is of specific interest to them, is located.

The situation is improved by using navigation points, which is a method whereby the user can bookmark an arbitrary location inside a web document. However, if access to navigation points is offered via a key press or a list, the user does not know where the navigation point(s) exits in the web page before the selection. Furthermore, the user does not know what the navigation point(s) represent, which in some instances can be an individual link or a full article or larger document. It would be advantageous if the navigation points on a web page could be marked, identified and visualized according to their location and size, to allow a user easily identify and navigate to such points on a web page.

### SUMMARY

In one aspect, the disclosed embodiments are directed to a method for highlighting navigation points on a web page using light sources. In one embodiment, the method includes browsing to a web page and selecting at least one area on the web page. The selected area is defined as a navigation point, and the navigation point is highlighted by being illuminated with a light source.

In another aspect, the disclosed embodiments are directed to a method for identifying navigation points on a web page. In one embodiment, the method includes accessing a web page and identifying at least one area on the web page by a light source corresponding to the at least one area. The identified area can then be scrolled to and the information or link associated with the area can be accessed.

In another aspect, the disclosed embodiments are directed to a system for highlighting navigation pointes on a web page. In one embodiment the system includes a user interface for a communication device, at least one light source in the communication device configured to direct at least one point of light on an identified area on the user interface, and a link illumination system configured to define a navigation point on a web page accessed by the communication device with a light source.

In a further aspect, the disclosed embodiments are directed to a computer program product comprising a computer useable medium having computer readable code means embodied therein for causing a computer to execute a set of instructions to illuminate a navigation point on a web page. In one embodiment, the computer readable code means in the computer program product includes computer readable program code means for causing a computer to define a selected area on the web page as the navigation point, and computer readable program code means for causing a computer to highlight the navigation point with a light source.

### BRIEF DESCRIPTION OF THE DRAWINGS

The foregoing aspects and other features of the embodiments are explained in the following description, taken in connection with the accompanying drawings, wherein:

FIG. 1 shows a schematic illustration of a system, as an example of an environment in which aspects of the embodiments may be applied.

FIG. 2 illustrates a screen shot of a web page incorporating features of the disclosed embodiments.

FIG. 3 illustrates an example of a display of a device incorporating aspects of the disclosed embodiments.

FIG. 4A illustrates a flow diagram of a method in accordance with the disclosed embodiments.

FIG. 4B illustrates a flow diagram of a method in accordance with the disclosed embodiments.

FIG. 4C illustrates a flow diagram of a method in accordance with the disclosed embodiments.

FIG. 5 is one example of a front view of a mobile device incorporating features of the disclosed embodiments.

FIG. 6 is a block diagram illustrating the general architecture of the exemplary mobile device of FIG. 5.

FIG. 7 illustrates one example of a schematic diagram of a network in which aspects of the disclosed embodiments may be practiced.

FIG. 8 illustrates a block diagram of an example of an apparatus incorporating features that may be used to practice aspects of the disclosed embodiments.

### DETAILED DESCRIPTION OF THE EMBODIMENT(s)

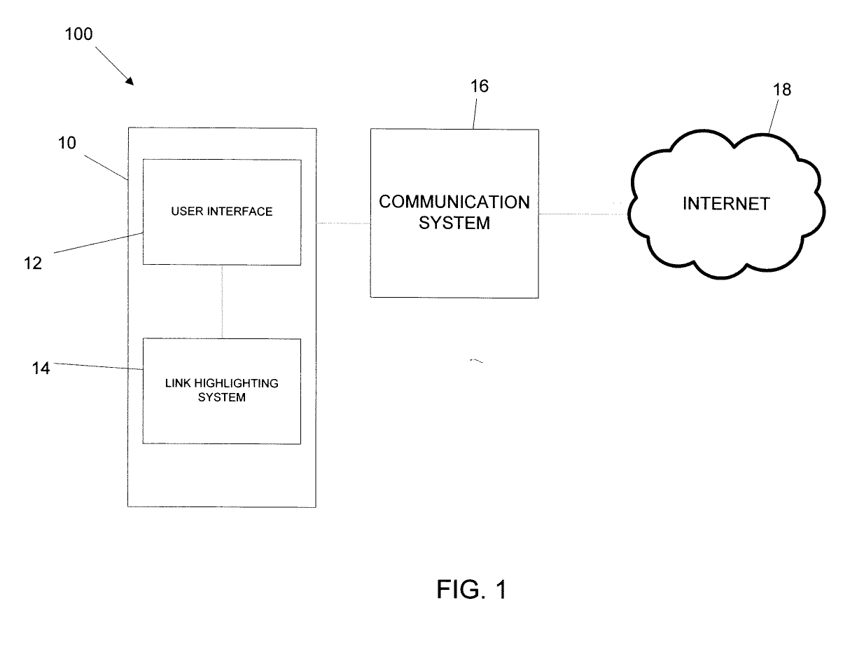

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow for the visualization of navigation points on a document or web page by one or more light sources. The navigation points on a webpage are identified by light sources making them easier to find and identify. The visualization can provide information to the user, such as the importance of the navigation point, or whether or not new or modified information is available at a navigation point.

Navigation points, as that term is used herein, generally refers to information that may be contained on a web page. A navigation point generally allows for a user to “bookmark” a particular location, such as a uniform resource locator or link, on a web page to make it easier and faster to return to the same location.

While the disclosed embodiments are described herein with reference to a “document” it should be understood that for purposes of the disclosed embodiments, a document may include information from a web site or a “web page,” an HTML or XML document, a text document, spreadsheet, graphics presentation, powerpoint presentation, PDF document, multimedia file, or any other suitable information presentation format that may include at least one link. Documents may be stored locally within device 10 or may be stored remotely. A link may include a reference or path to a location within a document or to another document. A link may include hypertext as is known in the art.

Referring to FIG. 1, one embodiment of a system 100 incorporating features of the claimed invention is illustrated. The user device 10 enables a user to set and view one or more navigation points in a web document or page, that are visualized by light. This improves the navigation inside web documents, particularly large web documents. The device 10 in FIG. 1 is configured to be able to communicate with a communication system 16. The communication system 16 is configured to communication with a network system, such as for example the Internet.

The device 10 generally includes a user interface 12 and a link highlighting system 14. The user interface 12, as will be described more fully herein, generally allows a user to interact with the device 10. The device 10 and user interface 12 can also include a web browser that allows the device to communicate with the communication system 16, and initiate requests and receive information and documents related to web pages.

The link highlighting system 14 is generally configured to allow a user to set navigation spots using light sources, as well as view the navigation spots. The link highlighting system 14 can be integral to the device 10 or can be coupled to the device 10 as an external component. When the device 10 comprises a mobile communication device that is configured to request and render web content, the link highlighting system 14 can comprise a web browser for the mobile communication device.

In one embodiment, referring to FI. 4A, after a user has accessed 401 a web page, an area on the web page can be selected 402. The selected area can be one that has some significance or importance to the user, or one to which the user would like to be able to easily return. The selection of the area can be done in any suitable fashion, including for example, using a mouse pointer or some other pointing or selection device, and activating a command from a menu of the device 10, a web browser menu, or selecting a shortcut key from the user interface 12 of the device. In alternate embodiments, the selection of an area on a web page can be executed in any suitable fashion.

The selected area can then be designated or set 403 as a navigation point by executing a command from the user interface 12 of the device 10. The setting of the navigation point can be implemented from a command available through the menu of the device 10 or web browser interface. Once the navigation spot is set, the navigation point will be marked on the web page displayed on the user interface 12 of the device 10 with a light source.

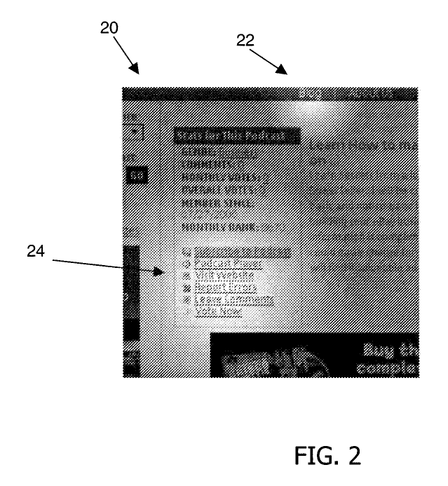

FIG. 2 is an illustration of an example of highlighting on a web page 20 using light sources. A web page can provide any number of links to additional information or other pages. In this example, the link to “Blog” 22 and the area 24 are highlighted by light sources. Thus, the user accessing this web page 20 can easily visualize the locations of these designated links due to the light sources. The navigation points can be visualized or marked with light sources in an overview of the web page and/or in a main view of the web page. In one embodiment, the link highlighting system 14 can be configured to allow a user to turn off the lighting of navigation points. This is advantageous, particularly when a web page contains a great deal of information.

In one embodiment, a user can set a priority for a navigation spot. A priority for a navigation point on a web page can be visualized in any number of ways, including for example, using different intensity values of the light source assigned to a particular navigation point. For example, in one embodiment, a navigation point that has a higher priority or importance to the user can have a higher light intensity or level applied to the navigation point and appear lighter, while a lower priority appears as a darker point, having less light intensity applied to the point. In alternate embodiments, any suitable mechanism to set a visual parameter for priority can be used, including for example, varying an intensity of the light source, varying a shape of the light source or even a color of the light source.

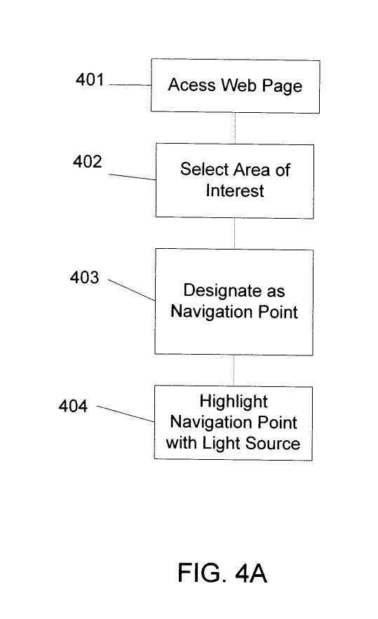

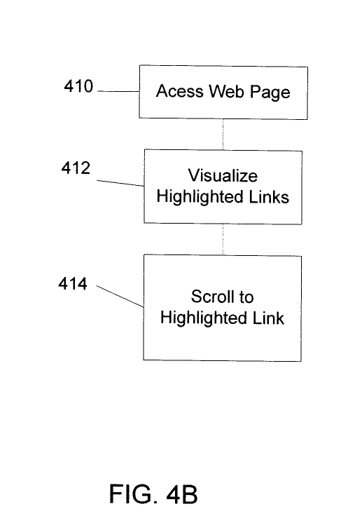

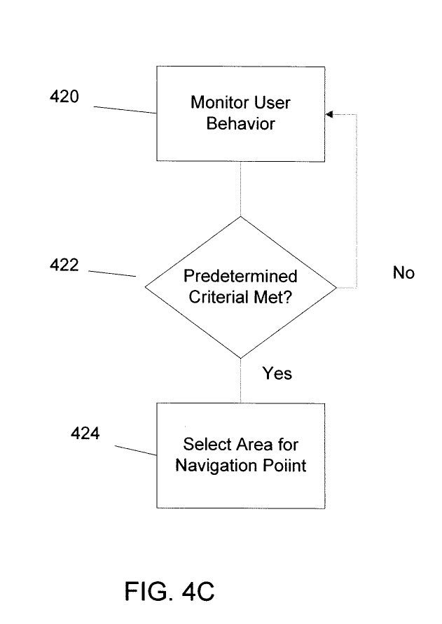

In addition to being able to manually select an area to be designated as a navigation point, as referred to with respect to FIG. 4A, in one embodiment a navigation point can automatically be set or defined. In one embodiment, the link highlighting system 14 if FIG. 1 can be configured to monitor user behavior with respect to information or areas of a document or web page. For example, with reference to FIG. 4C, if a user focuses for a period of time on a certain area or section of a web page, the area can automatically be selected for designation as a navigation point. The behavior of a user can be monitored 420, and if the behavior indicates 422 that a section of the document or web page has some significance or importance to the user, the section can be selected 424 for designation as a navigation point. In one embodiment, the user can be prompted to accept the area as a navigation point, or alternatively, the area can automatically be assigned as a navigation point. Similarly, if a user accesses an area of a document or web page repeatedly, the area can be selected 422 for designation as a navigation point. In alternate embodiments, any user behavior that is indicative of a section of a document or web page having increased significance to the user can be used to select the area for designation as a navigation spot. By monitoring user behavior and analyzing the document structure and style, the link highlighting system 14 can automatically decide upon a set of navigation points and mark them accordingly.

The priority of a navigation point can similarly automatically be assigned or designated. If a user accesses a section of the web page or document a certain number of times, or for a certain period of time, the link highlighting system 14 can automatically assign a priority level for the navigation point based upon this user behavior.

The deletion of navigation points can be executed by a control in the user interface 12 or by accessing a suitable command from a menu of the user interface 12 or a browser menu.

In one embodiment, if content associated with a navigation point is changed or updated, the light source associated with the navigation point can be made to vary in order to identify that there is new content. For example, if a navigation point has new content, the light source associated with the navigation point can be made to blink to signify the presence of the new content.

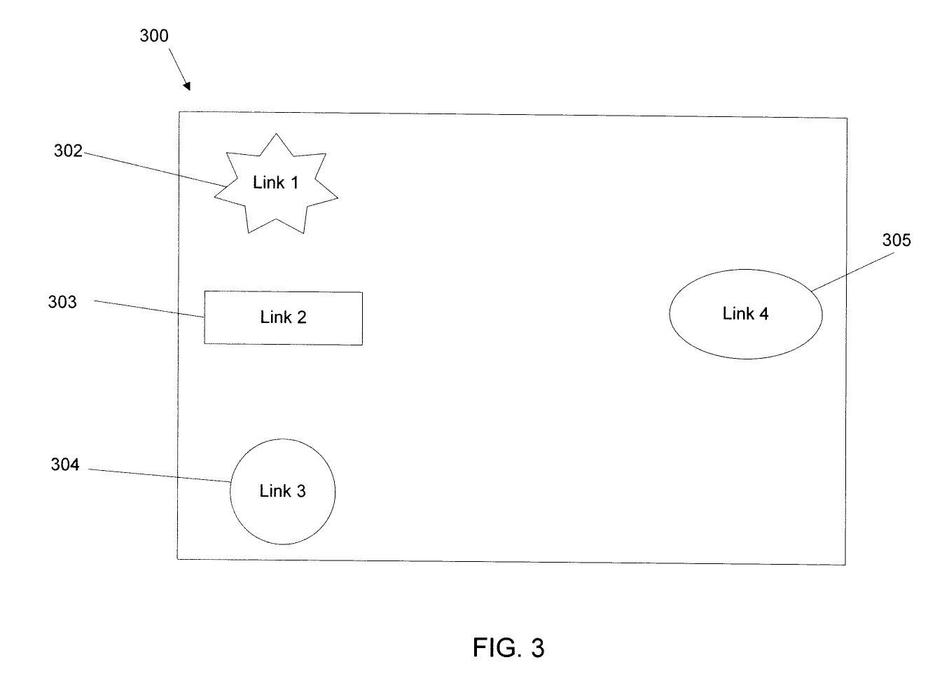

Referring to FIG. 3, the illumination area of a navigation point is not limited to any particular size or shape. While in an exemplary embodiment, the shape of the illuminated area is a cone, in alternate embodiments, and suitable geometric shape and size can be used. Different shapes and size can be used for different types of information or priority levels. For example, as shown in FIG. 3, a number of different information links on the web page or document 300 are shown. The link 302 is illuminated by a star shape, the link 303 in a rectangular shape, the link 304 in a circle or cone shape, and the link 305 by an ellipse shape. In another embodiment, each link can be illuminated by a different color as well.

In one embodiment, the light spots or illumination areas can be implemented using, for example, two dimensional (2D) rendering. Smooth animation and detailed light spots may require graphics hardware acceleration, which mobile devices will increasingly have capability for in the future. Light sources can be used to light navigation points in an overview. The data that is required to illuminate a navigation point is the location of the navigation point, the size of its area, and the priority. The location and size information can be used to determine the angle of the cone of the light source, and the priority information is used to set the intensity.

Storing a navigation point can include saving the location information of the upper-left corner of the navigation point on the web document. The location of bottom-right corner for the navigation point can be calculated and stored for size information related to the navigation point. Alternatively, the actual size of the area of the navigation, including the width and the height, can be stored.

In one embodiment, the link highlighting system 14, or the web browser, records the target of a request to add a navigation point as a pair of coordinates in the rendered document space. The pair is attached to the uniform resource locator (URL) for the web page. This method has the advantage of reduced complexity (i.e. there is no need for evaluating XPath expressions or string matching). Alternatively, the absolute coordinates could be replaced with relative coordinates (i.e. each coordinate is expressed as a percentage of the total document size along each axis).

In another embodiment web browser maintains a document object model (DOM) representation of the document viewed by the user. When a user generates an event to designate an area as a navigation point, the target of the event is a node in the DOM representation. In this embodiment, defining a navigation point consists of simply identifying the target of a request to designate an area as a navigation point event and automatically constructing an XPointer that refers to that target. The XPointer expression can be appended to the URL of the web page. The resulting URL uniquely identifies the location inside the document where the request to designate an area as a navigation point has occurred.

The XPointer can be determined by computing the XPath expression corresponding to the target node. This can be done by traversing the DOM representation along the ancestor axis and evaluating the position ( ) function for each node before the root.

If the HTML structure of the document is modified, there is a possibility that the XPointers identifying the navigation points would become invalid. In order to deal with such limitations, one alternative includes constructing an XPointer that contains several alternatives. However, the other alternatives can provide more relaxed matches. To illustrate this idea, the XPointer could include a reference to a keyword associated with the navigation point. In one embodiment, the location given by the XPath expression is identified and an attempt can be made to try to match the string value against the keyword. If a match is found, it can be concluded that the navigation point is valid. If the match fails, the keyword is searched in the same block-level element (in this case, a TABLE element) that contained the original navigation point. Finally, in case this alternative fails as well, the browser can fall back to the original location, despite the fact that the content has changed. If the original location does not exist anymore, the navigation point is lost.

Since the XPointer can refer any character inside a block of text (via the string-range( ) function, this solution is perfectly able to deal with the cases where a user sets a navigation point inside a large paragraph. Also, changes in the style of a document (i.e. changes in the cascading style sheet (CSS)) do not affect the navigation points since they are defined in a style-independent way.

In another embodiment, the browser or link highlighting system 14 records the navigation point as the original URL plus an XPointer expression, as described above, and a pair of coordinates. The evaluation of a navigation point starts with the XPointer and, in case it fails or generates ambiguities, the pair of coordinates is used as a backup.

For example, a user accesses a news portal that gathers information on a large number of topics, and when the web page for the news portal is accessed, all of these topics are displayed. If the topic that one is most interested in is located close to the bottom of the page, accessing the section requires a great deal of scrolling. In accordance with the disclosed embodiments, the user can selects the section of interest and defines the area as a navigation point. Other navigation points can be designated as well, and prioritized.

In accordance with the disclosed embodiments, every time the user opens the browser associated with the device and visits the new portal, the user first sees the defined navigation spots visualized in for example, the overview. Every navigation spot is marked with a dedicated light source that lights the area defined for each navigation spot. Every light source may have its own color or all of them can be the same. Furthermore, the browser may detect whether the area has some new content compared to the previous time the navigation point was accessed. This can be visualized by making the light sources blink if their navigation spot has some new content. The user can quickly navigate to the navigation spots on the same page by scrolling to the areas that are marked with light sources in the overview.

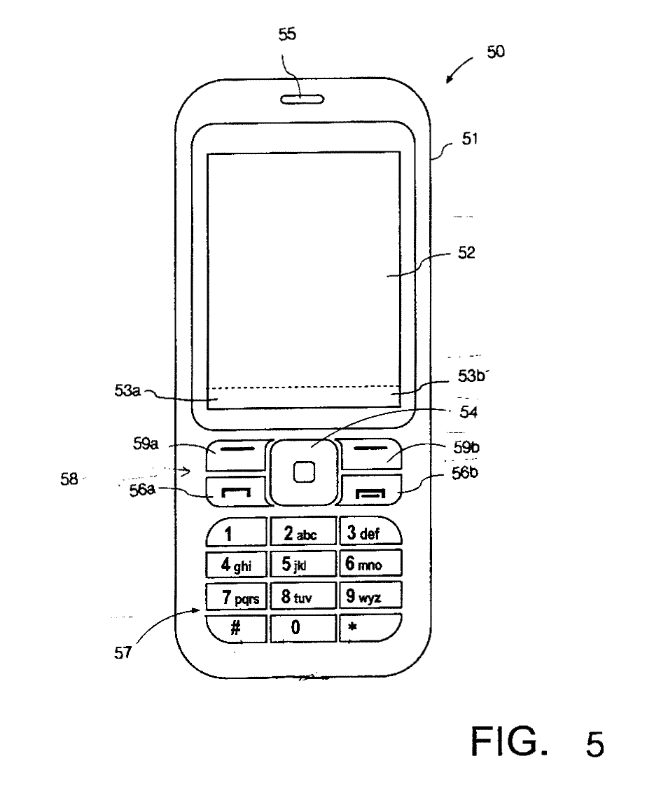

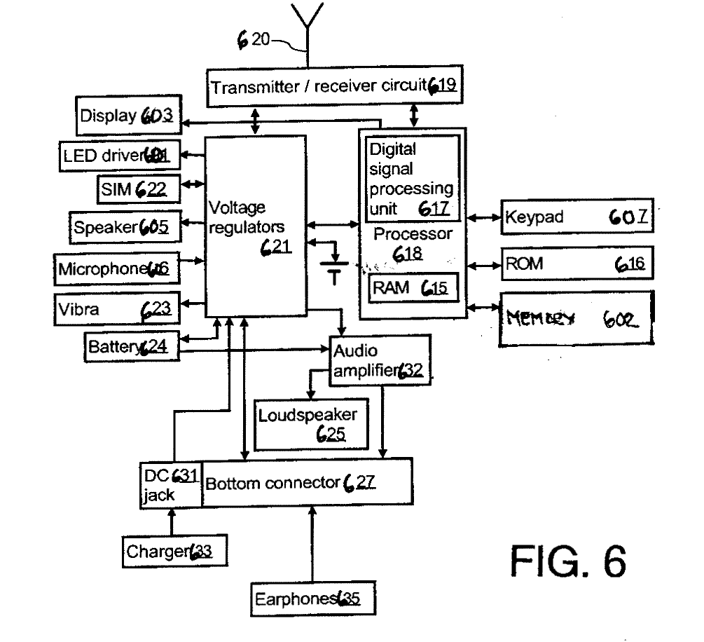

The user device 10 of FIG. 1 can generally comprise any suitable electronic device, such as for example a personal computer, a personal digital assistant (PDA), a mobile terminal, a smart phone, a mobile communication terminal in the form of a cellular/mobile phone, or a multimedia device or computer. FIG. 5 illustrates one embodiment of the device 10 of FIG. 1. In alternate embodiments, the device 10 of FIG. 1 may be a personal communicator, a tablet computer, a laptop or desktop computer, a television or television set top box or any other suitable device capable of containing for example a display 52 shown in FIG. 5, and support electronics such as the processor 618 and memory 602 of FIG. 6. For description purposes, the embodiments described herein will be with reference to a mobile communications device for exemplary purposes only and it should be understood that the embodiments could be applied equally to any suitable device incorporating a display, processor, memory and supporting software or hardware.

Referring to FIG. 5, in one embodiment, the mobile device 50 generally comprises a user interface having a housing 51, a display 52, an on/off button (not shown), an audio output device 55 (only the opening is shown), and an audio input device (not shown). The mobile device 50 is generally adapted for communication via a cellular network, such as for example, the GSM 900/1800 MHz network. In alternate embodiments, the mobile device is adapted for use on any suitable communication network, such as for example a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

Referring again to FIG. 5, in one embodiment the device 50 has a user interface that can include a user input device such as a keypad with first group of keys 57. The keys 57 can be alphanumeric keys and can be used for example to enter a telephone number, write a text message (SMS), or write a name (associated with the phone number). Each of the twelve alphanumeric keys 57 shown in FIG. 5 can be associated with a alphanumeric such as “A-Z’ or “0-9”, or a symbol, such as “#” or “*”, respectively. In alternate embodiments, any suitable number of keys can be used, such as for example a QUERTY keyboard, modified for use in a mobile device. In an alpha mode, each key 57 can be associated with a number of letters and special signs used in the text editing.

The user interface of the mobile device 50 can also include a second group of keys 58 that can include for example, soft keys 59a, 59b, call handling keys 56a, 56b, and a multi-function/scroll key 54. The call handling keys 56a and 56b can comprise a call key (on hook) and an end call (off hook). The keys 58 can also include a 5-way navigation key 54 (up, down, left, right and center: select/activate). The function of the soft keys 59a and 59b generally depends on the state of the device, and navigation in the menus of applications of the device can be performed using the navigation key 54. In one embodiment, the current function of each of the soft keys 59a and 59b can be shown in separate fields or soft labels in respective dedicated areas 53a and 53b of the display 52. These areas 53a and 53b can generally be positioned in areas just above the soft keys 59a and 59b. The two call handling keys 56a and 56b are used for establishing a call or a conference call, terminating a call or rejecting an incoming call. In alternate embodiment, any suitable or key arrangement and function type can make up the user interface of the device 50, and a variety of different arrangements and functionalities of keys of the user interface can be utilized.

In one embodiment, the navigation key 54 can comprise a four or five-way key which can be used for cursor movement, scrolling and selecting and is generally placed centrally on the front surface of the phone between the display 52 and the group of alphanumeric keys 57. In alternate embodiments, the navigation key 54 can be placed in any suitable location on user interface of the device 50.

A releasable rear cover (not shown) gives access to the SIM card (not shown), and the battery pack (not shown) in the back of the device that supplies electrical power for the electronic components of the device 50.

The display 51 of the device 50 can comprise any suitable display, such as for example, a touch screen display or graphical user interface. In one embodiment, the display 51 can be integral to the device 50. In alternate embodiments the display may be a peripheral display connected or coupled to the device 50. A pointing device, such as for example, a stylus, pen or simply the user's finger may be used with the display 52. In alternate embodiments any suitable pointing device may be used. In other alternate embodiments, the display may be any suitable display, such as for example a flat display 52 that is typically made of an LCD with optional back lighting, such as a TFT matrix capable of displaying color images. A touch screen may be used instead of a conventional LCD display.

The device 50 may also include other suitable features such as, for example, a camera, loudspeaker, connectivity port or tactile feedback features.

FIG. 6 illustrates in block diagram form one embodiment of a general architecture of the mobile device 50. The mobile communications device 50 may have a processor 618 connected to the display 603 for processing user inputs and displaying information on the display 603. The processor 618 controls the operation of the device and can have an integrated digital signal processor 617 and an integrated RAM 615. The processor 618 controls the communication with a cellular network via a transmitter/receiver circuit 619 and an internal antenna 620. A microphone 606 is coupled to the processor 618 via voltage regulators 621 transforms the user's speech into analog signals. The analog signals formed are A/D converted in an A/D converter (not shown) before the speech is encoded in the DSP 617 that is included in the processor 618. The encoded speech signal is transferred to the processor 618, which e.g. supports the GSM terminal software. The digital signal-processing unit 617 speech-decodes the signal, which is transferred from the processor 618 to the speaker 5 via a D/A converter (not shown).

The voltage regulators 621 form the interface for the speaker 605, the microphone 606, the LED drivers 601 (for the LEDS backlighting the keypad 607 and the display 603), the SIM card 622, battery 624, the bottom connector 627, the DC jack 631 (for connecting to the charger 633) and the audio amplifier 632 that drives the (hands-free) loudspeaker 625.

A processor 618 can also include memory 602 for storing any suitable information and/or applications associated with the mobile communications device 50 such as phone book entries, calendar entries, etc.

The processor 618 also forms the interface for peripheral units of the device, such as for example, a (Flash) ROM memory 616, the graphical display 603, the keypad 607, a ringing tone selection unit 626, and an incoming call detection unit 628. In alternate embodiments, any suitable peripheral units for the device 50 can be included.

The software in the RAM 615 and/or in the flash ROM 616 contains instructions for the processor 618 to perform a plurality of different applications and functions.

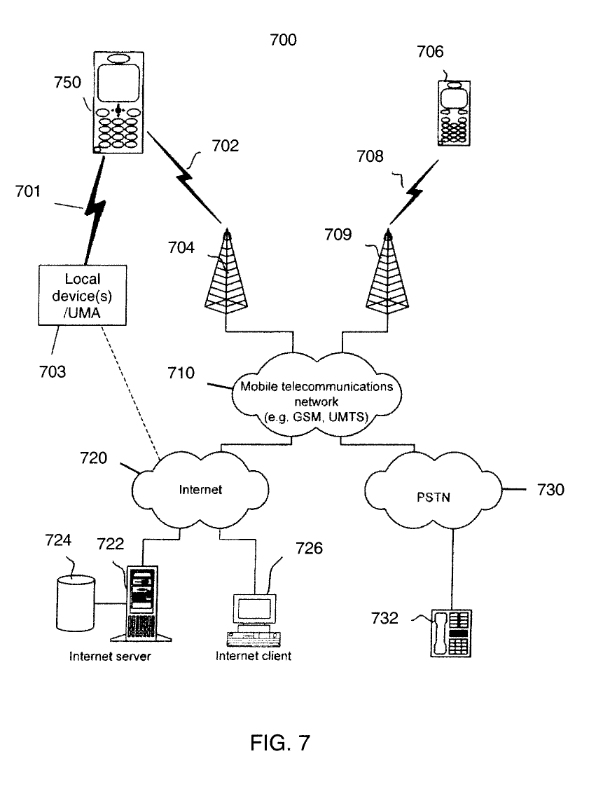

Referring to FIG. 7, one embodiment of a communication system in which the disclosed embodiments can be used is illustrated. In the communication system 100 of FIG. 7, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 750 and other devices, such as another mobile terminal 706, a stationary telephone 732, or an internet server 722. It is to be noted that for different embodiments of the mobile terminal 750 and in different situations, different ones of the telecommunications services referred to above may or may not be available. The aspects of the invention are not limited to any particular set of services in this respect.

The mobile terminals 750, 706 may be connected to a mobile telecommunications network 710 through radio frequency (RF) links 702, 708 via base stations 704, 709. The mobile telecommunications network 710 may be in compliance with any commercially available mobile telecommunications standard such as, for example, GSM, UMTS, D-AMPS, CDMA2000, FOMA and TD-SCDMA or other such suitable communication standard or protocol

The mobile telecommunications network 710 may be operatively connected to a wide area network 720, which may be the Internet or a part thereof. An Internet server 722 has data storage 724 and can be connected to the wide area network 720, as is for example, an Internet client computer 726. The server 722 may host a www/wap server capable of serving www/wap content to the mobile terminal 700. In alternate embodiments, the server 722 can host any suitable transaction oriented protocol.

For example, a public switched telephone network (PSTN) 730 may be connected to the mobile telecommunications network 710 in a familiar manner. Various telephone terminals, including the stationary telephone 732, may be connected to the PSTN 730.

The mobile terminal 750 is also capable of communicating locally via a local link 701 to one or more local devices 703. The local link 701 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values to the mobile terminal 700 over the local link 701. The above examples are not intended to be limiting, and any suitable type of link may be utilized. The local devices 703 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the Internet. The mobile terminal 750 may thus have multi-radio capability for connecting wirelessly using mobile communications network 710, WLAN or both. Communication with the mobile telecommunications network 710 may also be implemented using WiFi, WiMax, or any other suitable protocols, and such communication may utilize unlicensed portions of the radio spectrum (e.g. unlicensed mobile access (UMA)).

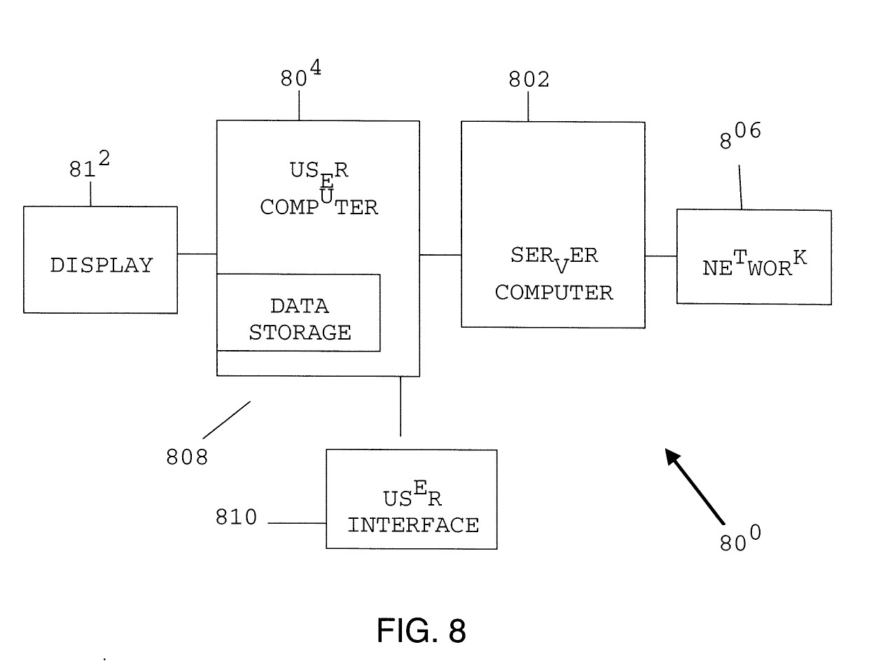

The disclosed embodiments may also include software and computer programs incorporating the process steps and instructions described above that are executed in different computers. FIG. 8 is a block diagram of one embodiment of a typical apparatus 800 incorporating features that may be used to practice aspects of the invention. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, hard wire connection, or fiber optic link. Generally, information can be made available to both computer systems 802 and 804 using a communication protocol typically sent over a communication channel or through a dial-up connection on ISDN line. Computers 802 and 804 are generally adapted to utilize program storage devices embodying machine-readable program source code, which is adapted to cause the computers 802 and 804 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and a display interface 812 from which aspects of the invention can be accessed. The user interface 810 and the display interface 812 can be adapted to allow the input of queries and commands to the system, as well as present the results of the commands and queries.

The disclosed embodiments generally provide for the visualization of navigation points on a web page using light sources. The user can define and set a view of navigation points on the web page, each area being marked with a light source. The priority of each navigation point can be set or defined by an intensity of the light source, and if content related to a navigation point has changed, the visualization of light source corresponding to the navigation point can be varied to indicate the presence of new content. This greatly improves the navigation inside larger web documents, particularly when such web documents are browsed using a mobile browser.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

1. A method comprising:
browsing to a web page;
selecting at least one area on the web page;
defining the selected area as a navigation point; and
highlighting the navigation point with a light source.

2. The method of claim 1 wherein highlighting the navigation point with a light source further comprises focusing at least one light source on the navigation point.

3. The method of claim 1 further comprising the at least one area being a link to another web page or web-related content.

4. The method of claim 1 wherein the web page is accessed using a mobile communication device.

5. The method of claim 1 wherein highlighting the navigation point further comprises:
determining location information corresponding to an upper left corner area of the navigation point;
determining location information corresponding to a bottom right corner area of the navigation point; and
illuminating an area in a region between the upper left corner area and the bottom right corner area of the navigation point.

6. The method of claim 1 wherein highlighting the navigation point further comprises:
determining location information corresponding to each corner area of the navigation point; and
illuminating an area in a region within each corner area.

7. The method of claim 1 wherein highlighting the navigation point further comprises:
determining a pair of coordinates in a rendered document space corresponding to the defined navigation point; and
attaching the pair of coordinates to a uniform resource locator for the web page, wherein when the web page is rendered, an area on the web page corresponding to the pair of coordinates is automatically highlighted.

8. The method of claim 1 wherein defining the selected area as a navigation point further comprises:
identifying a target area of the defined navigation point, the target comprising a node in a document object model representation of the web page;
automatically constructing a pointer that refers to the target area; and
appending the pointer referring to the target area to a uniform resource locator of the web page, wherein a resulting uniform resource locator identifies a location inside the web page as the navigation point.

9. The method of claim 8 further comprising defining the navigation point as the resulting uniform resource locator and a pair of coordinates in a rendered document space corresponding to an area of the defined navigation point.

10. The method of claim 1 further comprising setting an intensity of the light source based on a priority level for the navigation point, wherein different priority levels have different intensities.

11. The method of claim 10 further comprising automatically setting a priority level for the navigation point based on at least one of a number of times a user accesses the navigation point or a period of time a user accesses the navigation point.

12. The method of claim 1 wherein selecting the at least one area on the web page comprises:
monitoring a user's behavior with respect to the at least one area; and
if the user's behavior with respect to the at least one area satisfies a predetermined criteria, automatically selecting the at least one area.

13. The method of claim 12 wherein a user's behavior comprises at least one of a number of times an area of the web page is accessed or a period of time an area of the web page is accessed.

14. The method of claim 1 further comprising defining a size of the light source based on a location and size of the navigation point on the web page.

15. The method of claim 1 further comprising defining an angle of a cone of the light source based on a location and a size of the navigation point on the web page.

16. The method of claim 1 further comprising that each navigation point on the web page is defined by a different light intensity.

17. The method of claim 1 further comprising that each navigation point on the web page is defined by a different light shape.

18. The method of claim 1 further comprising varying a shape or intensity of the light source highlighting the navigation point if a content of information associated with the navigation point has changed since the last time a link corresponding to the navigation point has been accessed.

19. A method comprising:
accessing a web page; and
identifying at least one area on the web page by a light source corresponding to the at least one area.

20. The method of claim 19 further comprising the at least one area on the web page corresponding to a link on the web page.

21. The method of claim 19 further comprising identifying a priority of the at least one area by an intensity of the light source illuminating the at least one area in comparison to other illuminated areas.

22. The method of claim 19 further comprising identifying that information corresponding to the at least one area has changed since the last time the information was accessed by a variation in the light source.

23. The method of claim 22 wherein the variation in the light source is at least one of a change in intensity, a change in size, a change in color, or a change in shape.

24. The method of claim 19 further comprising accessing the web page using a mobile communication device.

25. The method of claim 19 further comprising scrolling to the at least one area on the web page identified by the light source corresponding to the at least one area.

26. The method of claim 19 further comprising that each identified area is marked with a dedicated light source.

27. A system comprising:
a user interface for a communication device;
at least one light source in the communication device configured to direct at least one point of light on an identified area on the user interface; and
a link illumination system configured to define a navigation point on a web page accessed by the communication device with a light source.

28. The system of claim 27 wherein the link illumination system is further configured to:
determining location information corresponding to an upper left corner area of the navigation point;
determine location information corresponding to a bottom right corner area of the navigation point; and
illuminate an area in a region between the upper left corner area and the bottom right corner area of the navigation point.

29. The method of claim 27 wherein the link illumination system is configured to:
determine location information corresponding to each corner area of the navigation point; and
illuminate an area in a region within each corner area.

30. The system of claim 27 wherein the link illumination system is configured to:
determine a pair of coordinates in a rendered document space corresponding to the defined navigation point; and
attach the pair of coordinates to a uniform resource locator for the web page, wherein when the web page is rendered, an area on the web page corresponding to the pair of coordinates is automatically highlighted.

31. The system of claim 27 wherein the link illumination system is configured to:
identify a target area of the defined navigation point, the target comprising a node in a document object model representation of the web page;
automatically construct a pointer that refers to the target area; and
append the pointer referring to the target area to a uniform resource locator of the web page, wherein a resulting uniform resource locator identifies a location inside the web page as the navigation point.

32. The system of claim 31 wherein the link illumination system is further configured to define the navigation point as the resulting uniform resource locator and a pair of coordinates in a rendered document space corresponding to an area of the defined navigation point.

33. The system of claim 27 wherein the link illumination system is further configured to set an intensity of the light source based on a priority level for the navigation point, wherein different priority levels have different intensities.

34. The system of claim 27 wherein the link illumination system is further configured to automatically set a priority level for the navigation point based on at least one of a number of times a user accesses the navigation point or a period of time a user accesses the navigation point.

35. The system of claim 27 wherein the link illumination system is further configured to:
monitor a user's behavior with respect to at least one area on the web page; and
if the user's behavior with respect to the at least one area satisfies a predetermined criteria, automatically select the at least one area as a navigation point.

36. The system of claim 27 wherein the link illumination system is further configured to vary a shape or intensity of the light source highlighting the navigation point if a content of information associated with the navigation point has changed since the last time a link corresponding to the navigation point has been accessed.

37. A computer program product comprising:
a computer useable medium having computer readable code means embodied therein for causing a computer to execute a set of instructions to illuminate a navigation point on a web page, the computer readable code means in the computer program product comprising:
computer readable program code means for causing a computer to define a selected area on the web page as the navigation point; and
computer readable program code means for causing a computer to highlight the navigation paint with a light source.

38. The computer program product of claim 37 further comprising computer readable program code means for causing a computer to set an intensity of the light source based on a priority level for the navigation point, wherein different priority levels have different intensities.

39. The computer program product of claim 37 further comprising computer readable program code means for causing the computer to automatically set a priority level for the navigation point based on at least one of a number of times a user accesses the navigation point or a period of time a user accesses the navigation point.

40 The computer program product of claim 37 further comprising computer readable program code means for causing the computer to monitor a user's behavior with respect to the at least one area, and if the user's behavior with respect to the at least one area satisfies a predetermined criteria, automatically selecting the at least one area as a navigation point.

41. The computer program product of claim 37 further comprising computer readable program code means for causing the computer to varying a shape or intensity of the light source highlighting the navigation point if a content of information associated with the navigation point has changed since the last time a link corresponding to the navigation point has been accessed.
